(19) United States
(12) Patent Application Publication
(10) Pub. No.: US 2017/0082653 A1
(43) Pub. Date: Mar. 23, 2017

(54) PHYSICAL QUANTITY SENSOR, PHYSICAL QUANTITY SENSOR DEVICE, ELECTRONIC APPARATUS, AND MOBILE BODY

(71) Applicant: Seiko Epson Corporation, Tokyo (JP)

(72) Inventor: Koichiro KOMIZO, Suwa (JP)

(21) Appl. No.: 15/264,866

(22) Filed: Sep. 14, 2016

(30) Foreign Application Priority Data
Sep. 18, 2015 (JP) 2015-184958

(51) Int. Cl. G01P 15/125

(52) U.S. Cl. CPC G01P 15/125

(57) ABSTRACT

A physical quantity sensor includes a base substrate, a movable unit which is disposed so as to be displaced with respect to the base substrate, a detecting electrode which is provided on the movable unit side of the base substrate, and is disposed so as to face the movable unit, and a conductive film which is provided on the base substrate side of the movable unit, and is disposed so as to face the detecting electrode, in which a difference in work function between the detecting electrode and the conductive film is 0.4 eV or less.

### BACKGROUND

1. Technical Field

The present invention relates to a physical quantity sensor, a physical quantity sensor device, an electronic apparatus, and a mobile body.

2. Related Art

For example, a physical quantity sensor (acceleration sensor) which is described in JP-A-2013-40856 includes a base substrate, a movable unit which can perform seesaw oscillation with respect to the base substrate, and an electrode which is provided on the base substrate, and is disposed facing the movable unit, in which a capacitance is formed between the movable unit and the electrode. In such a physical quantity sensor, since the movable unit performs seesaw oscillation when being subjected to acceleration, and the capacitance changes due to this, it is possible to detect the applied acceleration based on the change in the capacitance.

However, in such a configuration, since a material of the movable unit, and a material of the electrode are different (for example, the movable unit is formed of silicon, and the electrode is formed of Pt), there is a difference between a work function (charging amount) of the movable unit and a work function of the electrode, and as illustrated in FIG. 1, for example, the capacitance-voltage characteristics (hereinafter, referred to as CV characteristics) are shifted according to the difference in work function. In addition, when the movable unit is excessively displaced, and is in contact with the electrode, there is a concern that contact charging may occur, and the movable unit may bond to the base substrate.

For this reason, in the physical quantity sensor in JP-A-2013-40856, there is a problem in that detection accuracy of acceleration deteriorates.

### SUMMARY

An advantage of some aspects of the invention is that a physical quantity sensor, a physical quantity sensor device which is provided with the physical quantity sensor, an electronic apparatus, and a mobile body in which it is possible to suppress deterioration in detection accuracy of a physical quantity are provided.

The advantage can be obtained using the following aspect of the invention.

According to an aspect of the invention, there is provided a physical quantity sensor which includes a substrate, a movable unit which is disposed so as to be displaced with respect to the substrate, an electrode which is provided on the movable unit side of the substrate, and is disposed so as to face the movable unit, and a conductive unit which is provided on the substrate side of the movable unit, and is disposed so as to face the electrode, in which a difference in work function between the electrode and the conductive unit is 0.4 eV or less.

In this manner, it is possible to obtain a physical quantity sensor which can suppress deterioration in detection accuracy of a physical quantity.

In the physical quantity sensor according to the aspect of the invention, it is preferable to use the same material for the electrode and the conductive unit.

In this manner, it is possible to easily reduce a difference in work function between the electrode and the conductive unit.

In the physical quantity sensor according to the aspect of the invention, it is preferable that the movable unit include a first movable unit which is located on one side, and a second movable unit which is located on the other side, and in which an angular moment when being subjected to acceleration in an alignment direction of the substrate and the movable unit is larger than that of the first movable unit, and the first movable unit and the second movable unit perform seesaw oscillation with respect to the substrate.

In this manner, it is possible to obtain a physical quantity sensor which can detect acceleration in a thickness direction of the movable unit.

In the physical quantity sensor according to the aspect of the invention, it is preferable that the electrode have a first electrode which is disposed so as to face the first movable unit, and a second electrode which is disposed so as to face the second movable unit.

In this manner, it is possible to detect acceleration in the thickness direction of the movable unit with good accuracy.

In the physical quantity sensor according to the aspect of the invention, it is preferable that the movable unit include a base portion which can be displaced in an in-plane direction of the movable unit with respect to the substrate, and a movable electrode unit which is provided so as to protrude from the base portion.

In this manner, it is possible to obtain a physical quantity sensor which can detect acceleration in the in-plane direction of the movable unit.

In the physical quantity sensor according to the aspect of the invention, it is preferable that the electrode have the same potential as that of the movable unit.

In this manner, it is possible to suppress bonding of the mobile body to the substrate.

According to another aspect of the invention, there is provided a physical quantity sensor device which includes the physical quantity sensor according to the aspect of the invention, and an electronic component which is electrically connected to the physical quantity sensor.

In this manner, it is possible to obtain a physical quantity sensor device with high reliability.

According to yet another aspect of the invention, there is provided an electronic apparatus which includes the physical quantity sensor according to the aspect of the invention.

In this manner, it is possible to obtain an electronic apparatus with high reliability.

According to still yet another aspect of the invention, there is provided a mobile body which includes the physical quantity sensor according to the aspect of the invention.

In this manner, it is possible to obtain a mobile body with high reliability.

### BRIEF DESCRIPTION OF THE DRAWINGS

The invention will be described with reference to the accompanying drawings, wherein like numbers reference like elements.

FIG. 1 is a graph which illustrates capacitance-voltage characteristics.

FIG. 2 is a plan view of a physical quantity sensor according to a first embodiment of the invention.

FIG. 3 is a sectional view which is taken along line III-III in FIG. 2.

FIG. 4 is a sectional view which describes a manufacturing method of a functional element strip.

FIG. 5 is a sectional view which describes the manufacturing method of the functional element strip.

FIG. 6 is a sectional view which describes the manufacturing method of the functional element strip.

FIG. 7 is a sectional view which describes the manufacturing method of the functional element strip.

FIG. 8 is a schematic view which describes driving of the physical quantity sensor illustrated in FIG. 2.

FIG. 9 is a plan view of a physical quantity sensor according to a second embodiment of the invention.

FIG. 10 is a sectional view which is taken along line X-X in FIG. 9.

FIG. 11 is a plan view of a physical quantity sensor according to a third embodiment of the invention.

FIG. 12 is a sectional view which is taken along line XII-XII in FIG. 11.

FIG. 13 is a sectional view which illustrates a physical quantity sensor device according to a fourth embodiment of the invention.

FIG. 14 is a perspective view which illustrates a configuration of a mobile (or notebook) personal computer to which an electronic apparatus of the invention is applied.

FIG. 15 is a perspective view which illustrates a configuration of a mobile phone (also including PHS) to which the electronic apparatus of the invention is applied.

FIG. 16 is a perspective view which illustrates a configuration of a digital still camera to which the electronic apparatus of the invention is applied.

FIG. 17 is a perspective view which illustrates a vehicle to which a mobile body of the invention is applied.

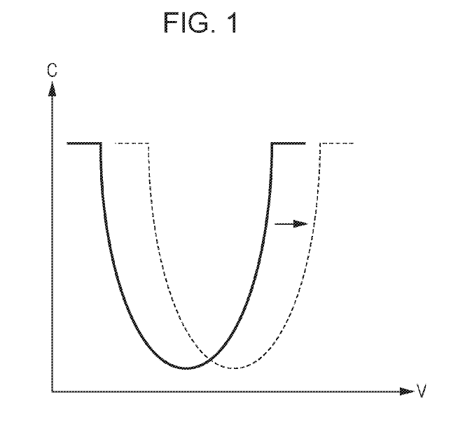

### DESCRIPTION OF EXEMPLARY EMBODIMENTS

Hereinafter, a physical quantity sensor, a physical quantity sensor device, an electronic apparatus, and a mobile body of the invention will be described in detail, based on embodiments which are illustrated in accompanying drawings.

### First Embodiment

First, a physical quantity sensor according to a first embodiment of the invention will be described.

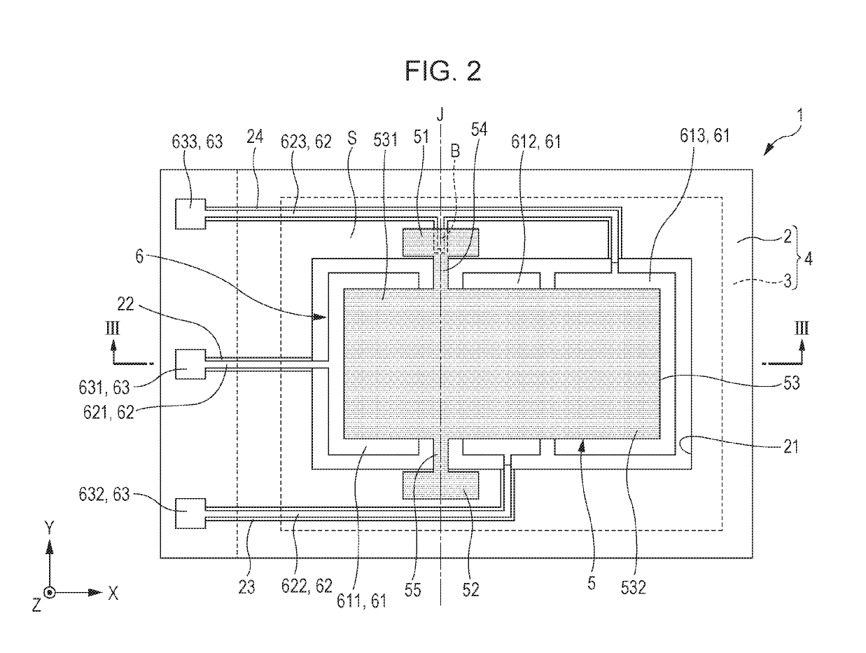

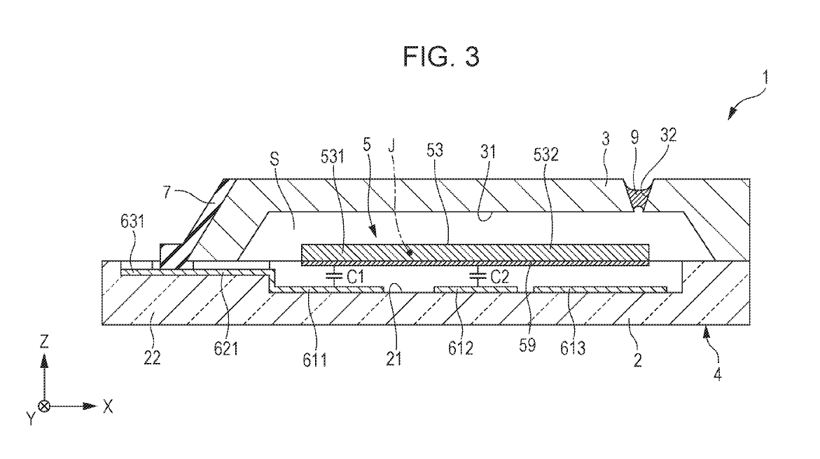

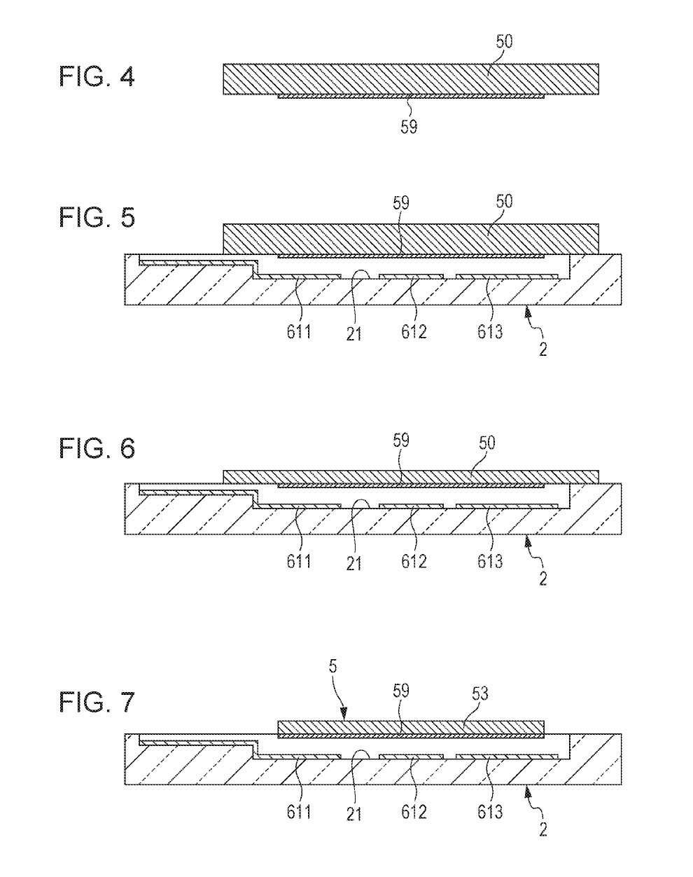

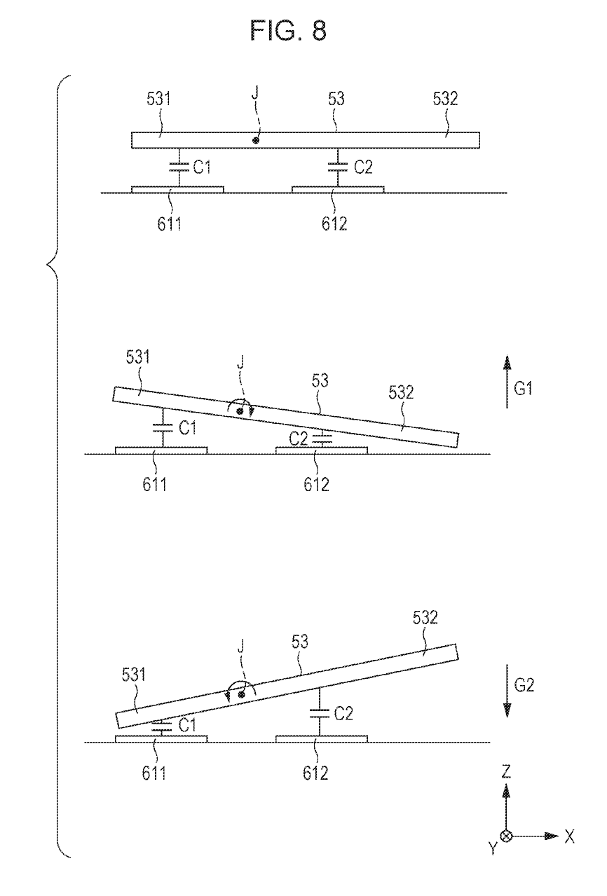

FIG. 2 is a plan view of the physical quantity sensor according to the first embodiment of the invention. FIG. 3 is a sectional view which is taken along line III-III in FIG. 2. FIGS. 4 to 7 are sectional views which describe a manufacturing method of a functional element strip, respectively. FIG. 8 is a schematic view which describes driving of the physical quantity sensor illustrated in FIG. 2. In addition, hereinafter, for ease of description, a near side on a paper face in FIG. 2 will be also referred to as an “upper side”, and a far side on the paper face will be also referred to as a “lower side”. In each figure, an X axis, a Y axis, and a Z axis are illustrated as three axes which are orthogonal to each other. In addition, hereinafter, a direction parallel to the X axis will be referred to as an “X axis direction”, a direction parallel to the Y axis will be referred to as a “Y axis direction”, and a direction parallel to the Z axis will be referred to as a “Z axis direction”. The Z axis direction is a vertical direction, and an XY plane is a horizontal plane.

A physical quantity sensor 1 which is illustrated in FIGS. 2 and 3 is an acceleration sensor which can measure acceleration in the Z axis direction (vertical direction). The physical quantity sensor 1 of this type includes a package 4 which is formed of a base substrate (substrate) 2 and a lid 3, a functional element strip 5 which is accommodated in an inner space S of the package 4, and a conductive pattern 6 which is disposed on the base substrate 2. Hereinafter, these elements will be described in order.

### Base Substrate

A recessed portion 21 which is open to a top face is formed on the base substrate 2. The recessed portion 21 functions as a clearance portion for preventing a contact between the functional element strip 5 and the base substrate 2. Three groove portions 22, 23, and 24 which are open to the top face and are connected to the recessed portion 21 are formed on the base substrate 2. In addition, wiring is disposed in the inside of these groove portions 22, 23, and 24, respectively. The base substrate 2 is formed of a glass substrate, for example, and an external shape thereof is formed, using etching, or the like. However, the base substrate 2 is not limited to a glass substrate, and for example, a silicon substrate, or the like, may be used. Functional element strip

The functional element strip 5 is provided above the base substrate 2. The functional element strip 5 includes a movable unit 53, connecting portions 54 and 55 which support the movable unit 53 so as to allow the movable unit 53 to oscillate, and supporting portions 51 and 52 which support the connecting portions 54 and 55. In addition, the movable unit 53 can perform seesaw oscillation with respect to the supporting portions 51 and 52, while causing the connecting portions 54 and 55 to be subjected to torsion deformation, by setting the connecting portions 54 and 55 to an axis J.

The movable unit 53 is formed in a longitudinal shape which extends in the X direction, and in which the −X direction side (one side) of the axis J is set to a first movable unit 531, and the +X direction side (the other side) of the axis J is set to a second movable unit 532. The second movable unit 532 is long in the X axis direction compared to the first movable unit 531, and, when subjected to acceleration, the angular moment in the vertical direction (Z axis direction) is set to be larger than that in the first movable unit 531. Due to a difference in the angular moment, the movable unit 53 performs seesaw oscillation around the axis J, when being subjected to acceleration in the vertical direction.

The shapes of the first and second movable units 531 and 532 are not limited, particularly, when the movable units have angular moments which are different from each other, and the movable units may have the same shape in plan view, and different thicknesses, for example. In addition, the movable units may have the same shape, and a weight may be disposed in any one of the movable units. In addition, slits (through holes which penetrate in the thickness direction) may be formed in the first and second movable units 531 and 532, in order to reduce a resistance when performing seesaw oscillating.

As illustrated in FIG. 3, a conductive film 59 is provided on a lower face (face which faces the bottom face of the recessed portion 21) of the movable unit 53. The conductive film 59 is electrically connected to the movable unit 53, and has the same potential as that of the movable unit 53. According to the embodiment, the conductive film is formed of platinum (Pt). However, as long as the constituent material of the conductive film 59 is a material with conductivity, it is not limited to Pt; for example, it may be a metal material (including alloys) other than Pt, such as Au, Ag, Cu, or Al, an oxide-based conductive material such as ITO (Indium Tin Oxide), IZO (Indium Zinc Oxide), In₃O₃, SnO₂, SnO₂ containing Sb, or ZnO containing Al, or the like, and it is possible to use one type, or a combination of two or more types of these.

The supporting portions 51 and 52 are disposed on both sides with the movable unit 53 interposed therebetween, and are bonded onto a top face of the base substrate 2. The connecting portions 54 and 55 extend along the Y axis. The connecting portion 54 connects the supporting portion 51 and the movable unit 53 to each other, and the connecting portion 55 connects the supporting portion 52 and the movable unit 53 to each other. In addition, the configurations of the supporting portions 51 and 52, or the connecting portions 54 and 55 are not particularly limited as long as it is possible to cause the movable unit 53 to perform seesaw oscillation.

The functional element strip 5 is configured of a silicon substrate. Due to this, the functional element strip 5 with an excellent external shape can be obtained, since it is possible to perform machining with high accuracy using etching. In addition, since it is possible to bond the functional element strip 5 (the supporting portions 51 and 52) to the base substrate 2 using anodic bonding, it is possible to obtain the physical quantity sensor 1 with high mechanical strength. The silicon substrate is doped with impurities such as phosphorus, and boron, and conductivity is provided to the functional element strip 5.

However, a material of the functional element strip 5 is not limited to silicon, and for example, it is possible to use another semiconductor substrate. In addition, also a method of providing conductivity to the functional element strip 5 is not limited to doping, and for example, a conductive layer of metal, or the like, may be formed on the surface of the movable unit 53.

When simply describing a method of forming the above-described functional element strip 5, as illustrated in FIG. 4, first, a silicon substrate (for example, P-type silicon substrate) 50 on which impurities are doped is prepared, and the conductive film 59 is formed on the lower face of the silicon substrate 50. Subsequently, as illustrated in FIG. 5, the silicon substrate 50 and the base substrate 2 are subjected to anodic bonding. Subsequently, as illustrated in FIG. 6, the silicon substrate is thinned so as to have a predetermined thickness. Subsequently, the silicon substrate 50 is patterned using dry etching, or the like. As described above, the functional element strip 5 which is bonded to the base substrate 2 is obtained, as illustrated in FIG. 7.

### Conductive Pattern

The conductive pattern 6 includes a detecting electrode (electrode) 61, wiring 62, and a terminal 63. The detecting electrode 61 is provided on a bottom face of the recessed portion 21, and includes a first detecting electrode 611, a second detecting electrode 612, and a dummy electrode 613. The first detecting electrode 611 is disposed so as to face the first movable unit 531, and due to this, a capacitance C1 is formed between the first detecting electrode 611 and the first movable unit 531. In addition, the second detecting electrode 612 is disposed so as to face the second movable unit 532, and due to this, a capacitance C2 is formed between the second detecting electrode 612 and the second movable unit 532. These first and second detecting electrodes 611 and 612 are symmetrically disposed with respect to the axis J in plan view, which is viewed from the Z axis direction, and capacitances C1 and C2 in a state in which acceleration is not applied are set to be approximately the same as each other.

The dummy electrode 613 is disposed so as to extend in a region on the bottom face of the recessed portion 21 in which the first detecting electrode 611 and the second detecting electrode 612 are not disposed. The dummy electrode 613 has the same potential as that of the movable unit 53, as will be described later, and due to this, it is possible to reduce an electrostatic force which occurs when the silicon substrate as the functional element strip 5 and the base substrate 2 are subjected to anodic bonding, and effectively suppress bonding (sticking) of the silicon substrate to the base substrate 2.

The wiring 62 includes wiring 621 which is disposed in the groove portion 22, and is electrically connected to the first detecting electrode 611, wiring 622 which is disposed in the groove portion 23, and is electrically connected to the second detecting electrode 612, and wiring 623 which is disposed in the groove portion 24, is electrically connected to the dummy electrode 613, and is electrically connected to the functional element strip 5 through a conductive bump B. In addition, the terminal 63 includes a terminal 631 which is disposed in the groove portion 22, and is electrically connected to the wiring 621, a terminal 632 which is disposed in the groove portion 23, and is electrically connected to the wiring 622, and a terminal 633 which is disposed in the groove portion 24 and is electrically connected to the wiring 623. In addition, the terminals 631, 632, and 633 are exposed to the outside of the package 4, respectively, and can be electrically connected to an external device.

According to the embodiment, the conductive pattern 6 is formed of platinum (Pt). Consequently, it is possible to reduce the electric resistivity of the conductive pattern 6, and reduce noise, or improve response characteristics. In addition, it is possible to obtain the conductive pattern with high temperature characteristics (reliability with respect to temperature). A base layer (for example, Ti layer) may be disposed between the conductive pattern 6 and the base substrate 2, in order to improve adhesion, as necessary.

As long as the constituent material of the conductive pattern 6 has conductivity it is not limited to Pt; for example, it may be a metal material (including alloys) such as Au, Ag, Cu, or Al other than Pt, an oxide-based conductive material, or the like, such as ITO, IZO, In₃O₃, SnO₂, SnO₂ containing Sb, or ZnO containing Al, or the like. It is possible to use one type, or a combination of two or more types of these. In addition, for example, the constituent material may be different from that of the detecting electrode 61, the wiring 62, and the terminal 63.

### Lid

The lid 3 includes a recessed portion 31 which opens to a lower face, and is bonded to the base substrate 2 so as to form the inner space S using the recessed portion 31 and the recessed portion 21. The lid 3 is formed of a silicon substrate. Consequently, it is possible to bond the lid 3 and the base substrate 2 using anodic bonding. However, the lid 3 may be formed of a glass substrate, for example.

Since the inside and outside of the inner space S communicate through the groove portions 22, 23, and 24, according to the embodiment, the groove portions 22, 23, and 24 are blocked by a SiO₂ film 7 which is formed, using a TEOS CVD method, or the like. In addition, the lid 3 includes a communicating hole 32 which communicates with the inside and outside of the inner space S. The communicating hole 32 is a hole for setting the inner space S to a desired environment, and is sealed, using a sealing member 9, after setting the inner space S to the desired environment.

Hitherto, a configuration of the physical quantity sensor 1 has been simply described. The physical quantity sensor 1 can detect acceleration in the vertical direction as follows. As illustrated in FIG. 8, in a case in which acceleration in the vertical direction is not applied to the physical quantity, the movable unit 53 maintains a horizontal state. In addition, when upward (+Z axis direction) acceleration G1 in the vertical direction is applied to the physical quantity sensor 1, the movable unit performs seesaw oscillation in a clockwise direction around the axis J. In contrast to this, when downward (−Z axis direction) acceleration G2 in the vertical direction is applied to the physical quantity sensor 1, the movable unit performs seesaw oscillation in a counterclockwise direction around the axis J. Due to such seesaw oscillation of the movable unit 53, the clearance between the first movable unit 531 and the first detecting electrode 611, and the clearance between the second movable unit 532 and the second detecting electrode 612 change, and the capacitances C1 and C2 change according to the change in clearance. For this reason, it is possible to detect a magnitude or orientation of acceleration based on the difference between the capacitances C1 and C2 (using a difference detecting method). In particular, it is possible to detect acceleration with good accuracy, using the difference detecting method.

In particular, in the physical quantity sensor 1, all of the first detecting electrode 611, the second detecting electrode 612, and the conductive film 59 are formed using platinum (Pt) as described above. That is, the first detecting electrode 611, the second detecting electrode 612, and the conductive film 59 are formed of the same material (contain the same material). For this reason, it is possible to set work functions of the first and second detecting electrodes 611 and 612, and a work function of the conductive film 59 to be the same (that is, it is possible to set difference in work function to be as close to 0 (zero) as possible), and reduce a shift of the CV characteristics which is described in the above-described “related art”. Accordingly, it is possible to suppress a deterioration in acceleration detecting characteristics, and exhibit desired acceleration detecting characteristics. In addition, as another effect, it is possible to suppress bonding of the movable unit 53 to the base substrate 2, when the movable unit 53 excessively oscillates, and is in contact with the bottom face of the recessed portion 21, for example, since it is possible to reduce contact charging between the first and second detecting electrodes 611 and 612 and the conductive film 59. In addition, as another effect, even when outgassing occurs inside the inner space S, and the outgassed gas becomes attached to the surfaces of the first and second detecting electrodes 611 and 612, or the surface of the conductive film 59, these surfaces are maintained at the same charging state as each other. For this reason, it is possible to reduce the occurrence of a difference in work function with time.

In addition, for example, also in a case in which both of the first and second detecting electrodes 611 and 612 and the conductive film 59 are formed of a material different from Pt (for example, ITO), it is possible to exhibit the same effect as that in the above description, as a matter of course.

Here, according to the embodiment, the first and second detecting electrodes 611 and 612, and the conductive film 59 are formed of the same material, and a difference in work function between the first and second detecting electrodes 611 and 612 and the conductive film 59 is set to (zero); however, it is possible to exhibit the same effect as that in the above description, when a difference in work function is 0.4 eV or less. The difference in work function is preferably 0.2 eV or less, and more preferably 0.1 eV or less. In addition, when the difference in work function is 0.4 eV or less, it is not necessary to form the first and second detecting electrodes 611 and 612, and the conductive film 59 using the same material, and the first and second detecting electrodes 611 and 612, and the conductive film 59 may be formed of different materials.

### Second Embodiment

Subsequently, a physical quantity sensor according to a second embodiment of the invention will be described.

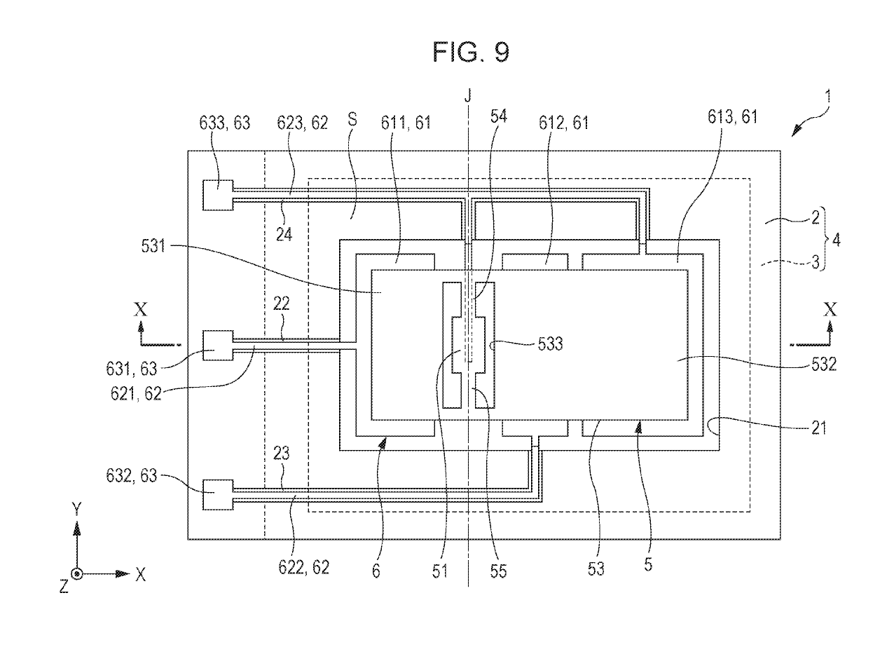

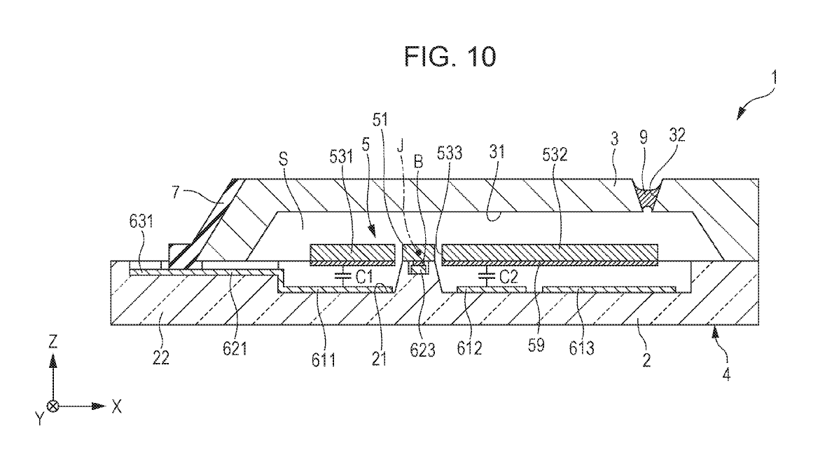

FIG. 9 is a plan view of the physical quantity sensor according to the second embodiment. FIG. 10 is a sectional view which is taken along line X-X in FIG. 9.

The physical quantity sensor according to the embodiment is the same as that in the above-described first embodiment, except for the functional element strip which has a different configuration.

In the following descriptions relating to the physical quantity sensor in the second embodiment, points different from the above-described embodiment will be mainly described, and descriptions of the same facts will be omitted. In addition, in FIGS. 9 and 10, the same configurations as those in the above-described embodiment are given the same reference numerals.

In the functional element strip 5 illustrated in FIGS. 9 and 10, an opening 533 is formed between the first movable unit 531 and the second movable unit 532 of the movable unit 53, and the supporting portion 51 which is fixed to the base substrate 2, and the connecting portions 54 and 55 which connect the supporting portion 51 and the movable unit 53 are provided inside the opening 533. With such a configuration, it is possible to reduce the size of the functional element strip 5 by an amount corresponding to the supporting portion 51, and the connecting portions 54 and 55 which are not provided on the outer side of the movable unit 53, for example, compared to that in the above-described first embodiment. In addition, it is possible to reduce distortion which is caused when transmission of stress from the base substrate 2 to the movable unit 53 is reduced, by disposing the supporting portion 51 which is supported by the base substrate 2 inside the first movable unit 531.

It is also possible to exhibit the same effect as that in the above-described first embodiment according to the second embodiment.

### Third Embodiment

Subsequently, a physical quantity sensor according to a third embodiment of the invention will be described.

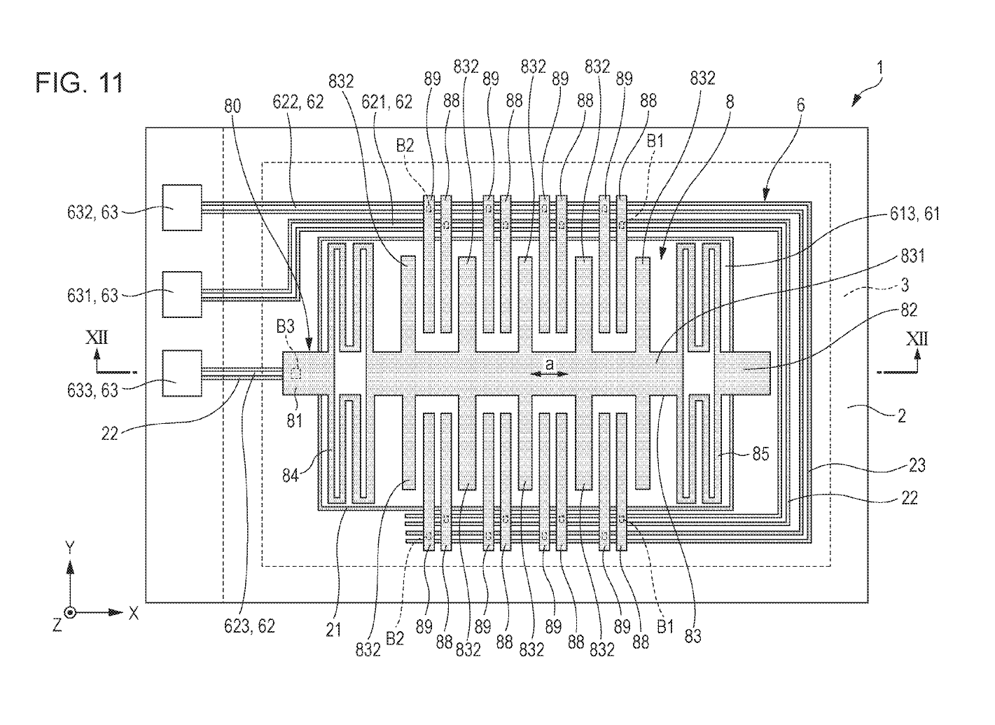

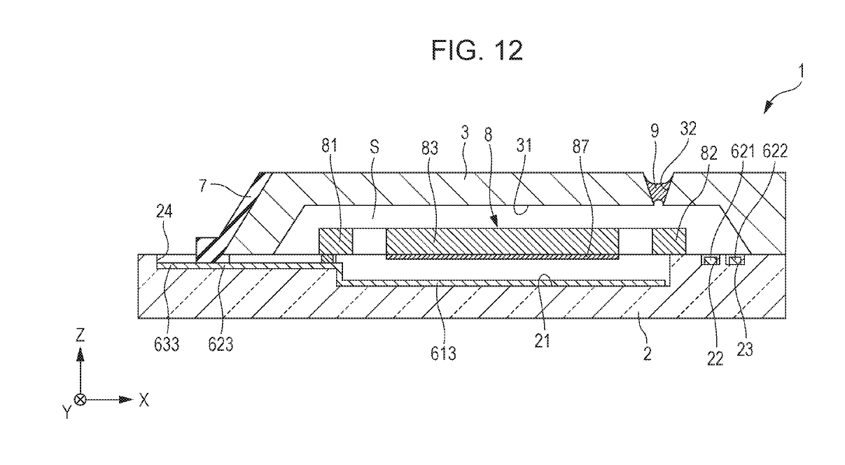

FIG. 11 is a plan view of a physical quantity sensor according to the third embodiment of the invention. FIG. 12 is a sectional view which is taken along line XII-XII in FIG. 11.

The physical quantity sensor according to the embodiment is the same as that in the above-described first embodiment, except for a functional element strip which has different configuration.

A functional element strip 8 which is illustrated in FIGS. 11 and 12 is an element which can measure acceleration in the X axis direction (in-plane direction of the functional element strip 8). The functional element strip 8 includes a movable structure 80 which is provided with supporting portions 81 and 82, a movable unit 83, and connecting portions 84 and 85, a plurality of first fixed electrode fingers 88, and a plurality of second fixed electrode fingers 89. The movable unit 83 includes a base portion 831, and a plurality of movable electrode fingers (movable electrode unit) 832 which protrude toward both sides in the Y axis direction from the base portion 831. The functional element strip 8 is formed of a silicon substrate on which impurities such as phosphorus and boron are doped, for example.

The supporting portions 81 and 82 are bonded to a top face of the base substrate 2, and are electrically connected to the wiring 623 through a conductive bump B3 in the supporting portion 81. In addition, the movable unit 83 is provided between the supporting portions 81 and 82, the movable unit 83 is connected to the supporting portion 81 through the connecting portion 84, and is connected to the supporting portion 82 through the connecting portion 85. In this manner, the movable unit 83 can be displaced in the X axis direction with respect to the supporting portions 81 and 82, as denoted by an arrow a, while causing the connecting portions 84 and 85 to be elastically deformed. In addition, as illustrated in FIG. 12, a conductive film (conductive unit) 87 is provided on a lower face of the movable unit 83, and the conductive film 87 is electrically connected to the movable unit 83, and has the same potential.

The plurality of first fixed electrode fingers 88 are disposed on one side of each movable electrode finger 832 in the X axis direction, and are aligned so as to form a comb tooth shape which is engaged with a corresponding movable electrode finger 832 with a gap. In addition, each of the first fixed electrode fingers 88 is bonded to a top face of the base substrate 2 at a base end portion thereof. Each of the first fixed electrode fingers 88 is electrically connected to the wiring 621 through a conductive bump B1.

In contrast to this, the plurality of second fixed electrode fingers 89 are disposed on the other side of each movable electrode finger 832 in the X axis direction, and are aligned so as to form a comb tooth shape which is engaged with a corresponding movable electrode finger 832 with a gap. In addition, each of the second fixed electrode fingers 89 is bonded to the top face of the base substrate 2 at a base end portion thereof. Each of the second fixed electrode fingers 89 is electrically connected to the wiring 622 through a conductive bump B2.

In addition, the dummy electrode 613 is disposed on the bottom face (the movable unit 83 facing the portion) of the recessed portion 21. The dummy electrode 613 is formed of the same material as that of the conductive film 87. The dummy electrode 613 is electrically connected to the wiring 623, and has the same potential as that of the movable structure 80. For this reason, it is possible to reduce an electrostatic force which is generated when the silicon substrate as the functional element strip 8 and the base substrate 2 are subjected to anodic bonding, and effectively suppress bonding (sticking) to the base substrate 2 of the silicon substrate.

The physical quantity sensor 1 detects acceleration as follows. That is, when acceleration in the X axis direction is applied to the physical quantity sensor 1, the movable unit 83 is displaced in the X axis direction based on a magnitude of the acceleration. Along with the displacement, a gap between the movable electrode finger 832 and the first fixed electrode finger 88, and a gap between the movable electrode finger 832 and the second fixed electrode fingers 89 are changed, respectively. Along with the displacement, the capacitance between the movable electrode finger 832 and the first fixed electrode finger 88, and the capacitance between the movable electrode finger 832 and the second fixed electrode fingers 89 are changed, respectively. For this reason, it is possible to detect a magnitude or orientation of acceleration based on the difference between the capacitances (using a difference detecting method).

In the physical quantity sensor 1, as described above, since the dummy electrode 613 and the conductive film 87 are formed of the same material, as described above, it is possible to set a difference in work function between the dummy electrode 613 and the conductive film 87 to 0 (zero), substantially. For this reason, since it is possible to reduce contact charging between the dummy electrode 613 and the conductive film 87, the movable unit 83 is displaced by receiving acceleration in the Z axis direction, for example, and it is possible to suppress bonding to the base substrate of the movable unit 83 when being in contact with the dummy electrode 613. In addition, as another effect, even when it is assumed that outgas is generated inside the inner space S, and the outgas is attached to the surface of the dummy electrode 613, or the surface of the conductive film 87, the surface states thereof are maintained at the same charging state. For this reason, it is possible to reduce an occurrence of a difference in work function with time.

According to the third embodiment, it is also possible to exhibit the same effect as that in the above-described first embodiment.

### Fourth Embodiment

Subsequently, a physical quantity sensor device according to a fourth embodiment of the invention will be described.

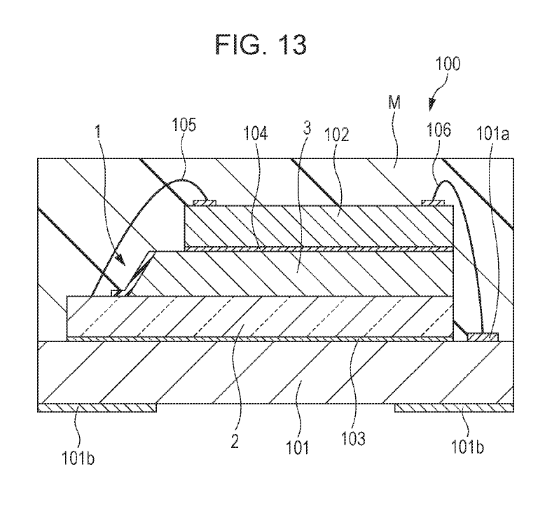

FIG. 13 is a sectional view which illustrates a physical quantity sensor device according to the fourth embodiment of the invention.

A physical quantity sensor device 100 illustrated in FIG. 13 includes a substrate 101, the physical quantity sensor 1 which is fixed to the substrate 101 through the adhesive layer 103, and an IC chip (electronic component) 102 which is fixed to the physical quantity sensor 1 through an adhesive layer 104. In addition, the physical quantity sensor 1 and the IC chip 102 are molded, using a molding material M. For the adhesive layers 103 and 104, it is possible to use, for example, solder, silver paste, a resin-based adhesive (die attach adhesive), or the like. In addition, as the molding material M, for example, it is possible to use a thermosetting epoxy resin, and it is possible to perform molding, using a transfer molding method, for example.

A plurality of terminals 101a are disposed on a top face of the substrate 101, and a plurality of mounting terminals 101b which are connected to the terminals 101a through internal wiring (not illustrated) are disposed on a lower face. The substrate 101 is not particularly limited; however, for example, it is possible to use a silicon substrate, a ceramic substrate, a resin substrate, a glass substrate, a glass epoxy substrate, and the like.

For example, a driving circuit which drives the physical quantity sensor 1, a detecting circuit which detects acceleration from a differential signal, an output circuit or the like which converts a signal from the detecting circuit into a predetermined signal, and outputs the predetermined signal, is included in the IC chip 102. The IC chip 102 is electrically connected to the terminals 631, 632, and 633 (not illustrated) of the physical quantity sensor 1 through a bonding wire 105, and is electrically connected to the terminal 101a of the substrate 101 through a bonding wire 106.

Since the physical quantity sensor device 100 is provided with the physical quantity sensor 1, the device has excellent reliability.

### Fifth Embodiment

Subsequently, an electronic apparatus according to a fifth embodiment of the invention will be described.

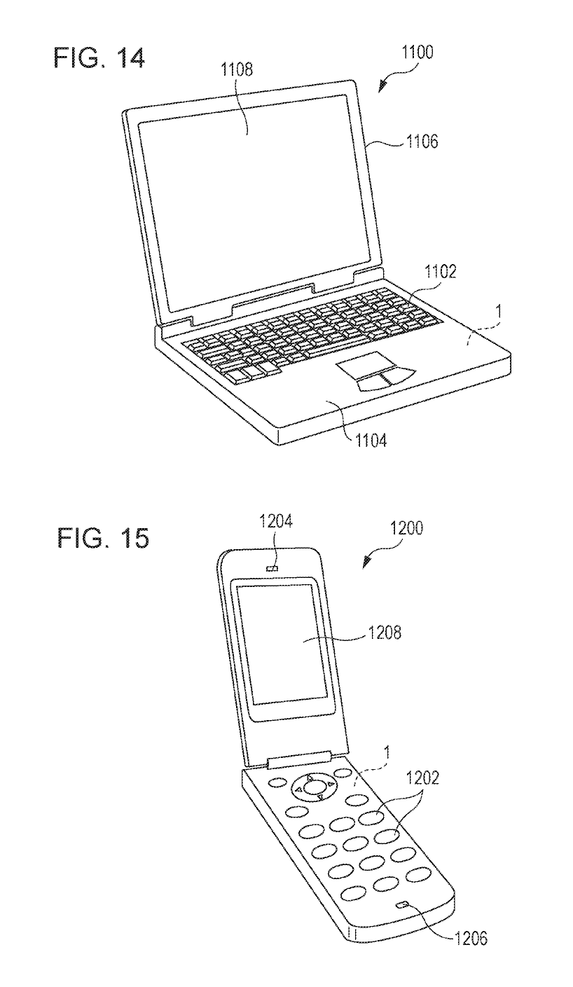

FIG. 14 is a perspective view which illustrates a configuration of a mobile (or notebook) personal computer to which the electronic apparatus of the invention is applied.

In the figure, a personal computer 1100 is formed of a main body unit 1104 which is provided with a keyboard 1102, and a display unit 1106 which is provided with a display section 1108, and the display unit 1106 is rotatably supported with respect to the main body unit 1104 through a hinge structure.

The physical quantity sensor 1 which functions as an acceleration sensor is built in the personal computer 1100.

FIG. 15 is a perspective view which illustrates a configuration of a mobile phone (including PHS) to which the electronic apparatus of the invention is applied.

In the figure, a mobile phone 1200 is provided with an antenna (not illustrated), a plurality of operation buttons 1202, an ear piece 1204, and a mouth piece 1206, and a display unit 1208 is disposed between the operation buttons 1202 and the ear piece 1204. The physical quantity sensor 1 which functions as an acceleration sensor is built in the mobile phone 1200.

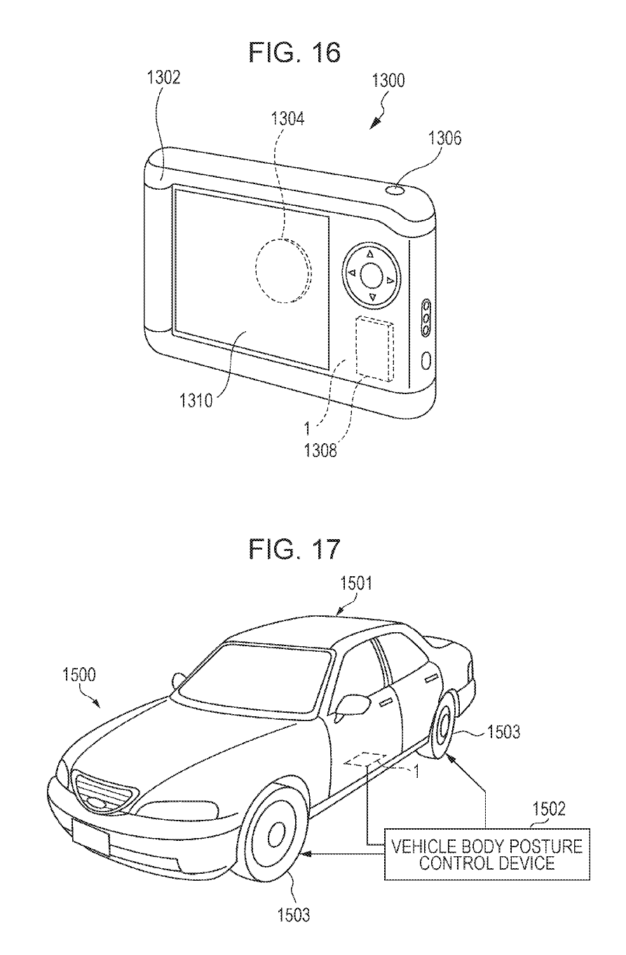

FIG. 16 is a perspective view which illustrates a configuration of a digital still camera to which the electronic apparatus of the invention is applied.

A display unit 1310 is provided on the rear face of a case (body) 1302 in a digital still camera 1300, has a configuration in which displaying is performed based on an imaging signal using CCD, and the display unit 1310 functions as a finder which displays a subject as an electronic image. In addition, a light receiving unit 1304 which includes an optical lens (of optical imaging system), CCD, or the like, is provided on the front face side (rear face side in figure) of the case 1302. In addition, when a photographer checks a subject image which is displayed on the display unit 1310, and presses a shutter button 1306, an imaging signal of the CCD at that time is transferred and stored in a memory 1308. For example, the physical quantity sensor 1 as an acceleration sensor for correcting hand shake is built in the digital still camera 1300.

Since the electronic apparatus is provided with the physical quantity sensor 1, the apparatus has excellent reliability.

The electronic apparatus in the invention can be applied to, for example, a smart phone, a tablet terminal, a clock, a wearable terminal such as a head mounted display, an ink jet ejecting apparatus (for example, ink jet printer), a laptop personal computer, a television, a video camera, a video tape recorder, a car navigation device, a pager, an electronic organizer (including electronic organizer with communication function), an electronic dictionary, an electronic calculator, an electronic game device, a word processor, a work station, a television phone, a crime preventing television monitor, electronic binoculars, a POS terminal, medical equipment (for example, electronic thermometer, sphygmomanometer, blood sugar meter, electrocardiogram measurement device, ultrasonic diagnostic device, electronic endoscope), a fish finder, various measurement devices, instruments (for example, instruments for cars, airplanes, and ships), a flight simulator, and the like, in addition to the personal computer in FIG. 14, the mobile phone in FIG. 15, and the digital still camera in FIG. 16.

### Sixth Embodiment

Subsequently, a mobile body according to a sixth embodiment of the invention will be described.

FIG. 17 is a perspective view which illustrates a vehicle to which the mobile body of the invention is applied.

As illustrated in FIG. 17, the physical quantity sensor 1 is built in a vehicle 1500, and for example, it is possible to detect a posture of a vehicle body 1501 using the physical quantity sensor 1. A detecting signal of the physical quantity sensor 1 is supplied to a vehicle body posture control device 1502, and the vehicle body posture control device 1502 detects a posture of the vehicle body 1501 based on the signal, and can control the hardness and softness of suspension, or control the brakes of individual wheels 1503 according to a detected result. In addition, the physical quantity sensor 1 can be widely applied to a keyless entry, an immobilizer, a car navigation system, a car air-conditioner, an antilock brake system (ABS), an air bag, a tire pressure monitoring system (TPMS), an engine control, an electronic control unit (ECU) of a battery monitor, or the like, of a hybrid car, or an electric car.

Hitherto, the physical quantity sensor, the physical quantity sensor device, the electronic apparatus, and the mobile body of the invention have been described based on the embodiments which are illustrated; however, the invention is not limited to these, and a configuration of each unit can be replaced with an arbitrary configuration with the same function. In addition, another arbitrary component may be added to the invention.

In addition, in the above described embodiments, the configuration in which the physical quantity sensor has one element strip in the inner space has been described; however, the number of element stripes which are disposed in the inner space is not particularly limited. For example, when two functional element strips 8 according to the above-described third embodiment are disposed in order to detect acceleration in the X axis and the Y axis, and when one functional element strip 5 according to the above-described first embodiment is disposed in order to detect acceleration in the Z axis, it is possible to obtain a physical quantity sensor which can independently detect acceleration in the X axis, Y axis, and Z axis. In addition, an element stripe which can detect angular velocity is added as a functional element strip, it can be used as a compound sensor which can detect acceleration and angular velocity.

In addition, a physical quantity which is detected by the physical quantity sensor is not limited to acceleration, and for example, it may be an angular velocity, a pressure, or the like. A configuration of the physical quantity sensor is not limited to the above-described configuration, and as long as it is a configuration in which it is possible to detect a physical quantity, it is not particularly limited. For example, it may be a flap-type physical quantity sensor, or it may be a parallel-plate physical quantity sensor.

The entire disclosure of Japanese Patent Application No. 2015-184958, filed Sep. 18, 2015 is expressly incorporated by reference herein.

What is claimed is:

1. A physical quantity sensor comprising:
a substrate;
a movable unit which is disposed so as to be displaced with respect to the substrate;
an electrode which is provided on the movable unit side of the substrate, and is disposed so as to face the movable unit; and
a conductive unit which is provided on the substrate side of the movable unit, and is disposed so as to face the electrode,
wherein a difference in work function between the electrode and the conductive unit is 0.4 eV or less.

2. The physical quantity sensor according to claim 1,
wherein the same material is used for the electrode and the conductive unit.

3. The physical quantity sensor according to claim 1,
wherein the movable unit includes a first movable unit which is located on one side, and a second movable unit which is located on the other side, and in which an angular moment when being subjected to acceleration in an alignment direction of the substrate and the movable unit is larger than that of the first movable unit, and
wherein the first movable unit and the second movable unit perform seesaw oscillation with respect to the substrate.

4. The physical quantity sensor according to claim 3,
wherein the electrode has a first electrode which is disposed so as to face the first movable unit, and a second electrode which is disposed so as to face the second movable unit.

5. The physical quantity sensor according to claim 1,
wherein the movable unit includes a base portion which can be displaced in an in-plane direction of the movable unit with respect to the substrate, and a movable electrode unit which is provided so as to protrude from the base portion.

6. The physical quantity sensor according to claim 5,
wherein the electrode has the same potential as that of the movable unit.

7. The physical quantity sensor according to claim 2,
wherein the movable unit includes a first movable unit which is located on one side, and a second movable unit which is located on the other side, and a second movable unit which is located on the other side, and in which an angular moment when being subjected to acceleration in an alignment direction of the substrate and the movable unit is larger than that of the first movable unit, and
wherein the first movable unit and the second movable unit perform seesaw oscillation with respect to the substrate.

8. The physical quantity sensor according to claim 7,
wherein the electrode has a first electrode which is disposed so as to face the first movable unit, and a second electrode which is disposed so as to face the second movable unit.

9. The physical quantity sensor according to claim 2,
wherein the movable unit includes a base portion which can be displaced in an in-plane direction of the movable unit with respect to the substrate, and a movable electrode unit which is provided so as to protrude from the base portion.

10. The physical quantity sensor according to claim 9,
wherein the electrode has the same potential as that of the movable unit.

11. A physical quantity sensor device comprising:
the physical quantity sensor according to claim 1; and
an electronic component which is electrically connected to the physical quantity sensor.

12. An electronic apparatus comprising:
the physical quantity sensor according to claim 1.

13. A mobile body comprising:
the physical quantity sensor according to claim 1.
